(19) United States
(12) Patent Application Publication
(10) Pub. No.: US 2008/0300347 A1
(43) Pub. Date: Dec. 4, 2008

(54) Adhesive Formulation, Method for Production and Use Thereof

(75) Inventors: Gunter Kurz, Tamins (CH); Manuel Senn, Chur (CH)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: EMS-CHEMIE AG, Domat/Ems (CH)

(21) Appl. No.: 12/091,024

(22) PCT Filed: Oct. 26, 2006
(86) PCT No.: PCT/EP2006/010333

§ 371 Date: Aug. 4, 2008

(30) Foreign Application Priority Data
Oct. 31, 2005 (DE) 10 2005 052 025.1

(51) Int. Cl. C08K 5/29; C08K 5/34

(52) U.S. Cl. 524/86; 524/196

(57) ABSTRACT

The invention relates to an adhesive formulation for the treatment of reinforcing layers which are provided for the production of reinforced polymer products, the adhesive formulation containing dissolved epoxide.

The invention relates to an adhesive formulation for the treatment of reinforcing layers which are provided for the production of reinforced polymer products, the adhesive formulation containing dissolved epoxide.

It has proved to be favourable in the production of fibre-reinforced rubber products if a bonding agent is used in order to improve the adhesion between textile reinforcing layer and the rubber. The use of such a bonding agent is important in particular in the field of tyre cord and other highly loaded composite materials with reinforcing fibres. It is known from the state of the art in particular for this field of application to use resorcinol-formaldehyde-latex systems (RFL) for connecting synthetic fibres to rubber products.

The process can thereby take place either in a one-step or in a two-step method. It has been shown in practice that essentially only the two-step method leads to satisfactory results in particular in the case of non-activated polyester fibres. In the two-step method, firstly activation of the fibres is undertaken in a first step such that the latter are coated with epoxide and/or with isocyanate. Generally, this is achieved with an aqueous dispersion in which the isocyanate and/or the epoxide is contained in the aqueous dispersion with a specific solid content. Subsequent to this first step, coating with a resorcinol-formaldehyde-latex system is then undertaken in a second step. It is ensured by this two-step method that, in the first step, complete activation of the fibres is effected such that the coating with epoxide and/or with isocyanate leads to the formation of active functional groups on the surface of the fibre so that, with the second step, the treatment with the latex can then be effected. The treatment with RFL is likewise effected with an aqueous dispersion.

The two-step method is however complex from a process engineering point of view and also the provision of two separate dispersions and handling thereof is difficult.

There has therefore been no lack of attempts to implement the treatment in the form of a one-step process. One-step systems are described for example in US 2002/0122938 and also in U.S. Pat. No. 3,419,450. The one-step systems, i.e. the application of an aqueous dispersion with RFL and also epoxide and isocyanate, was however in practice not able to be accomplished even for the treatment of already activated fibres. Activated fibres are fibres which have been provided with a coating, e.g. an epoxide coating, just after production. In the case of one-step processes, these thus previously activated fibres are again treated with a dispersion. In the US patent 2002/0122938, it is thereby proposed to use a one-step system which contains also special epoxides in addition to RFL and isocyanate. The epoxide is however also contained, in US 2002/0122938, in the form of a solid in the dispersion. The disadvantage in this one-step system is that it cannot be applied to non-activated fibres and that also the results with already activated fibres, in particular with respect to wetting and adhesion, are unsatisfactory.

Starting herefrom, it is the object of the present invention to propose an adhesive formulation which can be applied in the form of a one-step system, the adhesive formulation being intended to have good wetting and good adhesion and also a high reaction speed on non-activated fibres, in particular PET fibres. It is a further object of the present invention to propose a corresponding method for the production of such a formulation and to indicate the use.

The object with respect to the adhesive formulation is achieved by the features of patent claim 1, with respect to the method by the features of patent claim 13. The sub-claims reveal advantageous developments.

According to the invention, an adhesive dispersion is proposed hence for a one-step system for the treatment of reinforcing layers for the production of reinforced polymer products, in which the epoxide is contained in dissolved form with a concentration of 0.001 to 5 mol relative to 1000 g of the total formulation, whereas the isocyanate and the RFL continue to be as solids. The applicant was able to show that it is possible to operate with such a formulation in which the epoxide is present in dissolved form with a one-step system and at the same time to achieve the advantages of the previous two-step system, namely the selectivity with respect to the coating. The adhesive formulation according to the invention however leads not only to selective wetting, i.e. firstly activation of the fibre takes place and then subsequently coating with solids contained in the dispersion but, with the adhesive formulation according to the invention, excellent adhesion of untreated polyester cords to the rubber is achieved in addition. It has been shown furthermore that, with the formulation according to the invention, a reduction in penetration depth occurs so that the concentration of adhesive was able to be lowered. The consequence of this is that the coated cords have less rigidity and hence have better stability.

In the case of the adhesive formulation according to the invention, it is thereby preferred if the concentration of epoxide is 0.002 to 0.2 mol/1000 g of the total formulation. Suitable epoxides which dissolve in the dispersion are in particular those which have a molecular weight of 50 to 2000. Particularly preferred are epoxides with a molecular weight of 50 to 1000, particularly preferred with a molecular weight of 50 to 290, in particular water-soluble polyglycidyl ethers, epoxy-novolak resins, polyfunctional alkylene epoxides, diglycide ethers and bisphenol-A based on resins. However the invention also comprises all the epoxides cited in EP 1 221 456 A1.

The adhesive formulation according to the invention has a solid content of 1 to 50% by weight, preferably of 1 to 30% by weight. The particle size of the particles present in the dispersion, i.e. the isocyanate, is <5 μm.

The solid proportion of the dispersion is thereby composed of 0.1 to 20% by weight of the isocyanate and 0.1 to 40% by weight of the RFL. Preferably the formulation contains 0.1 to 10% by weight of isocyanate and 10 to 25% by weight of RFL as solid proportion.

In addition, it has proved to be advantageous with the adhesive formulation if there are used as isocyanates 4-4-diisocyanate-diphenylmethane (MDI) and/or toluenediisocynate (TDI) and/or naphthylisocyanate (NDI). However the invention of course comprises also all other known isocyanates which can be used for adhesive formulations of this type. In this respect, reference is made by way of example to US 2002/0122938 A1 and the diisocyanates described there.

There have proved to be favourable blocking agents in the isocyanates in the present invention, in particular lactam-blocked isocyanates. Examples of these are ε-copralactam, d-valerolactam. However the invention of course comprises also other known blocking agents. These are: oximes, e.g. methyl ethyl ketoxime (butanone oxime), methyl amyl ketoxime and cyclohexanon oxime. Monophenols, e.g. phenol, resorcinol, cresol, trimethylphenols, tert. butylphenols. Primary, secondary and tertiary alcohols, glycol ethers, light enol-forming compounds, such as e.g. acetoacetic esters, acetyl acetone, malonic acid derivates. Secondary aromatic amines. Imides, mercaptans, triazoles.

A further rise in the reaction speed in the adhesion formulation according to the invention can also be achieved in that a catalyst is added in the form of a metal compound. There are thereby suitable as catalysts metal compounds of the metals sodium, potassium, caesium, strontium, silver, cadmium, barium, cerium, uranium, titanium, chromium, tin, antimony, manganese, iron, cobalt, nickel, copper, zinc, lead, calcium and/or zirconium. In the case of the metal compounds, those of zinc are preferred. Suitable compounds are hereby zinc acetate, zinc sulphate, zinc carbonate, zinc oxide, zinc acetyl acetonate and/or zinc chloride. Zinc acetate is very particularly preferred. The catalyst is present in dissolved form in the dispersion, the concentration being 0.0001 to 0.1 mol/1000 g of the formulation.

The resorcinol-formaldehyde-latex system (RFL) which is used according to the present invention is known per se from the state of the art.

The invention relates furthermore to a method for the treatment of reinforcing layers for the production of reinforced polymer products (patent claim 13). In the case of the method according to the invention, an adhesion formulation as described previously is used. In the case of the method, the adhesive formulation can also thereby be produced shortly before the intended application by mixing the individual components. In what form the individual components are present, is thereby of no importance, i.e. also two or more components can be mixed in advance.

However it is essential in the present invention that the adhesive formulation is applied in the form of a one-step system, i.e. all the components must be present before the treatment already in the form of an aqueous dispersion and/or solution. It is not essential for achieving success to what extent the aqueous dispersion is prepared for a fairly long time before application as a unitary formulation or whether the individual components were mixed shortly before application.

Furthermore, the applicant was able to show that the adhesive formulation according to the invention is suitable in particular for the treatment of untreated polyester fibres. Excellent reaction speeds were able hereby to be achieved which were significantly above those known previously from comparable systems, a good wetting rate being achieved at the same time.

The invention is explained subsequently in more detail with reference to an embodiment.

### EXAMPLE

A dip according to the invention was produced with the composition cited in Table 1.

TABLE 1
Formulation of the one-step dip

| Dip component | Quantity | | Solids | | |
|---|---|---|---|---|---|
| lactam blocked MDI | 29.35 | g | 29.35 | g | 5.87% |
| polyglycidyl ether¹ | 10.65 | g | 10.65 | g | 2.13% |
| RFL² | 260.87 | g | 60.00 | g | 12.00% |
| water deionised | 199.13 | g | | | |
| Total | 500.00 | g | 100.00 | g | 20.00% |

¹present in dissolved form
²23% in deionised water

A non-activated PET cord was treated once with a two-step dip of the state of the art and with a dip according to the invention with the composition indicated in Table 1. In the case of the two-step dip, a dip of the state of the art was used. In the first dip, Grilbond® IL-6 50% F was used as blocked isocyanate and, as epoxide, Grilbond® G1701 of the company EMS-Primid AG, Switzerland. The dispersion for the 2^{nd} step concerns a condensation product from a resorcinol-formaldehyde resin and a butadiene-styrene-vinylpyridine latex.

In Table 2, the results for both dips are compared.

TABLE 2

| | | Two-step dip | One-step dip |
|---|---|---|---|
| Formulation | IL-6 + | 2.7%¹ | 1.7%¹ |
| | G1701 | | |
| | RFL | 6.3%¹ | 5.8%¹ |
| Properties | Adhesion² | 5 | 5 |

¹DPU: Quantity of bonding agent on the PET after coating
²Cord rubber covering: 1 = 0-20%, 2 = 20-40%, 3 = 40-60%, 4 = 60-80%, 5 = 80-100%.

1. Adhesive formulation in the form of an aqueous dispersion with a solid content of 1 to 50% containing:
a) 0.001 to 5 mol of an epoxide with a molecular weight of 50-290 in dissolved form, relative to 1000 g of the total formulation
b) 0.1 to 20% of a totally or partially blocked isocyanate, as solid and
c) 0.1 to 40% of a resorcinol-formaldehyde-latex (RFL) as solid.

2. Adhesive formulation according to claim 1, wherein the solid content is 5 to 30%.

3. Adhesive formulation according to claim 1 which contains 0.002 to 0.20 mol epoxide in dissolved form, relative to 1000 g of the total formulation.

4. Adhesive formulation according to claim 1, wherein the epoxide is selected from the group consisting of polyglycidyl ethers, epoxy-novolak resins, polyfunctional alkylene epoxides, diglycide ethers and bisphenol-A based resins.

5. Adhesive formulation according to claim 1, wherein the formulation contains 0.0001 to 0.1 mol of a metal compound as catalyst in dissolved form, relative to 1000 g of the total formulation, the catalyst being selected from the metals zinc, strontium, cadmium, sodium, caesium, potassium, silver, barium, titanium, chromium, tin, antimony, manganese, iron, cobalt, nickel, cerium, uranium, copper, calcium, zinc, lead and zirconium.

6. Adhesive formulation according to claim 5, wherein the catalyst is a zinc compound selected from zinc acetate, zinc acetyl acetonate, zinc oxide, zinc chloride, zinc carbonate and/or zinc sulphate.

7. Adhesive formulation according to claim 1, wherein the isocyanate is blocked with a lactam.

8. Adhesive formulation according to claim 1, wherein the isocyanate is selected from 4,4-diisocyanate-diphenylmethane (MDI) and/or toluenediisocynate (TDI) and/or naphthyldiisocyanate (NDI).

9. Adhesive formulation according to claim 1, which contains in addition additives and/or dispersion agents.

10. Adhesive formulation according to claim 1, which contains 0.1 to 10% of blocked or partially blocked isocyanate as solid and 10 to 25% of RFL as solid.

11. Adhesive formulation according to claim 1, wherein the particle diameter of the isocyanate solids is <5 μm.

12. A method for treating reinforcing layers during the production of reinforced polymer products comprising applying the adhesive formulation according to claim 1 to the reinforcing layers.

13. The method according to claim 12, wherein the adhesive formulation is produced immediately before the treatment by mixing the individual components.

14. The method according to claim 12, wherein the adhesive formulation is produced immediately before application by mixing the component c) (RFL) into the formulation already present as mixture with the components a) and b).

15. The method according to claim 12, wherein a non-activated tyre cord is treated.

16. Adhesive formulation according to claim 2 which contains 0.002 to 0.20 mol epoxide in dissolved form, relative to 1000 g of the total formulation.

17. Adhesive formulation according to claim 2, wherein the epoxide is selected from the group consisting of polyglycidyl ethers, epoxy-novolak resins, polyfunctional alkylene epoxides, diglycide ethers and bisphenol-A based resins.

18. Adhesive formulation according to claim 2, wherein the formulation contains 0.0001 to 0.1 mol of a metal compound as catalyst in dissolved form, relative to 1000 g of the total formulation, the catalyst being selected from the metals zinc, strontium, cadmium, sodium, caesium, potassium, silver, barium, titanium, chromium, tin, antimony, manganese, iron, cobalt, nickel, cerium, uranium, copper, calcium, zinc, lead and zirconium.

19. Adhesive formulation according to claim 2, wherein the catalyst is a zinc compound selected from zinc acetate, zinc acetyl acetonate, zinc oxide, zinc chloride, zinc carbonate and/or zinc sulphate.

20. Adhesive formulation according to claim 2, wherein the isocyanate is blocked with a lactam.
